(19) United States
(12) Patent Application Publication
(10) Pub. No.: US 2014/0278638 A1
(43) Pub. Date: Sep. 18, 2014

(54) WORKFORCE PRODUCTIVITY TOOL

(71) Applicant: SPRINGSHOT, INC., San Francisco, CA (US)

(72) Inventors: Douglas Paul KREUZKAMP, Burlingame, CA (US); Eric Paul PHELAN, Oakland, CA (US)

(73) Assignee: SPRINGSHOT, INC., San Francisco, CA (US)

(21) Appl. No.: 13/797,313

(22) Filed: Mar. 12, 2013

(51) Int. Cl. G06Q 10/06

(52) U.S. Cl. CPC G06Q 10/06398
USPC 705/7.15

(57) ABSTRACT

Systems and processes for managing worker profiles and worker tasks are provided. Tasks may be dispatched to mobile devices of workers, and workers may report the completion of those tasks using their mobile devices. Workers may earn scores for completing tasks. A worker profile may be maintained for each worker to reflect experience, performance, certifications, awards, and the like. The profile may include a cumulative experience score that reflects the experience level of the associated worker. As workers complete tasks, their profiles may be automatically updated to reflect additional work experience, including incrementing the cumulative experience score. Different experience levels may be obtained and various rewards and recognitions may be given and reflected in worker profiles as cumulative experience scores increase. Worker profiles may also include an overall performance rating that may be updated based on the timeliness and quality of task completion.

### BACKGROUND

1. Field

This application relates generally to workforce management and, more specifically, to systems and processes for managing and tracking human resources and their tasks.

2. Related Art

Worker disengagement is estimated to cost employers hundreds of billions of dollars each year in lost productivity. Such disengagement is particularly common in jobs where workers perform repetitive tasks—commonly referred to as “blue collar” work. To supervise and manage blue collar workers, Mobile Resource Management (MRM) tools were developed to allow companies to dispatch work orders and track employees via smartphones. While these tools initially reduced overhead costs and offered companies better insight into daily operations, they have stagnated while mobile technology has advanced. As a result, current MRM tools fail to deliver an engaging user experience, contrasting starkly with the dynamic consumer smartphone applications that today's blue collar workers use in their personal lives.

Current MRM tools are also not intuitive to blue collar workers. MRM tools typically run on older operating systems and outdated hardware that are becoming less and less familiar. In addition, MRM tools typically present instructions to users in English-only text, alienating many blue collar workers who are only partially literate or speak English as only a second language. As a result, these tools fail to capture worker attention and miss an opportunity to provide useful guidance. They also fail to provide meaningful feedback. MRM tools collect raw performance data and share the data with a company's executives and managers. They share little, if anything, directly with the workers, leading workers to view the tools as unidirectional: workers exhaust themselves inputting the data but see little benefit in return. Even where executives and managers share data generated by MRM tools, the feedback is often delayed, limiting its value in enhancing worker performance.

Current MRM tools further lack functional breadth and adaptability. For example, current MRM tools may be narrowly-tailored applications for collecting very specific data for specific worker tasks. Companies are often forced to rely on separate applications, systems, and programs to provide workforce management tools, such as hierarchical workflow management, training materials, employee feedback, and the like. Separating these workforce management tools may lead to incompatibility issues and increased management expense. Current MRM tools also lack adaptability for keeping up with rapid changes in work requirements, client demands, and various other work environment changes that can quickly render existing MRM tools ill-equipped for certain situations and certain tasks.

Thus, systems and processes for engaging and motivating human resources, improving worker productivity, and better managing and tracking tasks are desired.

### SUMMARY

Systems and processes for managing worker profiles and worker tasks are described. A project may be generated, via a processor, for a worker to complete. The project may include a set of tasks. A subset of the set of tasks may be transmitted, over a wireless network, to a mobile device of the worker. A notification may be received that one or more tasks of the subset of the set of tasks are complete. A cumulative experience score associated with a worker profile of the worker may be accessed from a database. The cumulative experience score may be updated based on the notification that the one or more tasks of the subset of the set of tasks are complete. The updated cumulative experience score may be stored in the database.

Instructions may also be transmitted to the mobile device of the worker for completing a task of the subset of the set of tasks. The instructions may include images of acceptable and unacceptable task completions or outcomes, and may also include a list of provisions for completing the task. An expected time of task completion may also be transmitted to the mobile device of the worker. Data may be received corresponding to an elapsed time for completing the task, and a cumulative performance rating associated with the worker profile may be updated based on the data. An audit request may be transmitted to a mobile device of an auditor. A request for photographic documentation of audit feedback may also be transmitted to the mobile device of the auditor. Photographic documentation of audit feedback may be received, and the photographic documentation may be transmitted to the mobile device of the worker who completed the audited tasks.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary process for managing worker profiles and worker tasks.

FIGS. 2A and 2B illustrate an exemplary team management interface.

FIGS. 3A and 3B illustrate an exemplary project generation and project management interface, respectively.

FIG. 4 illustrates an exemplary project management interface.

FIG. 5 illustrates an exemplary task assignment view.

FIGS. 6A and 6B illustrate exemplary task assignment views.

FIGS. 7A, 7B, and 7C illustrate exemplary task instruction views.

FIGS. 8A and 8B illustrate exemplary task completion views indicating unsatisfactory and satisfactory task completion, respectively.

FIG. 9 illustrates an exemplary project site arrival interface.

FIG. 10 illustrates an exemplary project start interface.

FIGS. 11A and 11B illustrate exemplary task tracking interfaces.

FIG. 12 illustrates an exemplary notification of unacceptable task completion time.

FIGS. 13A and 13B illustrate exemplary visual indicators of elapsed task completion time.

FIG. 14 illustrates an exemplary task completion interface.

FIG. 15 illustrates an exemplary project status and score review interface.

FIG. 16 illustrates an exemplary worker profile with cumulative work experience scores.

FIGS. 17A, 17B, and 17C illustrate exemplary worker profiles with certifications, awards, and statistics, respectively.

FIGS. 18A, 18B, and 18C illustrate exemplary project audit interfaces.

FIGS. 19A and 19B illustrate exemplary project audit feedback interfaces.

FIGS. 20A and 20B illustrate exemplary project audit reports with summary scores and audit documentation, respectively.

FIG. 21 illustrates an exemplary system for managing worker profiles and worker tasks.

FIG. 22 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below relating to systems and processes for managing worker profiles and worker tasks. For example, a workforce productivity tool may be used to manage workers and their tasks. An exemplary workforce productivity tool may include servers, workstations, laptops, tablet computers, mobile devices, software, Internet interfaces, databases, and the like. A server may be configured to communicate with mobile devices used by a mobile workforce. Tasks may be dispatched to the mobile devices, and the workers may report the completion of those assigned tasks using their mobile devices. Game-thinking and game mechanics may be incorporated into routine work to better engage workers in their assigned tasks (“gamification”).

A profile may be maintained for each worker to reflect experience, performance, certifications, awards, and the like. The profile may include, for example, a cumulative experience score that reflects the experience level of the associated worker. As workers complete tasks, their profiles may be automatically updated to reflect additional work experience. For example, the cumulative experience score may be incremented to reflect newly completed tasks and additional work experience. As the cumulative experience score increases, different experience levels may be obtained and various rewards and recognitions may be given to workers. The associated profiles may likewise be updated to reflect new experience levels, rewards, recognitions, and the like. In some embodiments, the virtual work record included in a worker profile may be used in making career advancement decisions, awarding merit-based promotions, and the like.

Some or all elements of a worker's profile may be visible within an organization, within related organizations, within a social network, or to the public at large. Worker profiles may be updated in real-time, thereby immediately rewarding workers for completed tasks, giving workers an important sense of satisfaction, and also permitting real-time competition among similarly situated workers. Leaderboards may also be provided that may rank workers based on recent achievements, cumulative experience levels, quality, timeliness, or any of a variety of other factors, further encouraging healthy competition and rewarding worker performance.

An exemplary process for managing worker profiles and worker tasks may include generating a project, manually or algorithmically, for an individual or team of workers to complete. The project tasks may be transmitted to a mobile device used by a worker. Workers may complete their assigned tasks and track their progress using their mobile devices. As workers complete tasks, they may earn points and performance scores associated with their worker profiles. Notifications of task completion may be received, and the worker profiles may be updated based on the newly completed tasks. For example, cumulative experience scores in each of the workers' profiles may be incremented or otherwise updated to reflect the completion of project tasks. In this manner, worker profiles—including scores, levels, rewards, and the like—may be maintained in real-time. Workers may receive direct and immediate feedback through mobile devices regarding the quality and timeliness of their work performance. The feedback may be shared in a system incorporating game mechanics and in a familiar and intuitive format that engages and motivates workers while centrally managing project tasks to improve performance and efficiency.

For illustrative purposes, the various embodiments discussed herein are related to personnel tasked with cleaning an airplane cabin in between flights. However, the various systems and processes may readily be adapted for other applications. For example, a janitorial staff tasked with cleaning a building may receive assignments on mobile devices, track their progress on their mobile devices, and have their profiles updated as they gain experience and meet performance goals. Similarly, airline employees tasked with assisting disabled passengers may receive gate and passenger assignments on their mobile devices, track passenger handling, and receive profile updates based on task completion and customer satisfaction. Various other applications that may benefit from the various embodiments discussed herein are also contemplated, such as hotel housekeeping, bus cleaning, commercial security, freight handling, airline baggage handling, hotel room service, chauffeuring, building maintenance, and the like. Accordingly, the various embodiments and examples discussed herein should be considered illustrative, with many other applications readily recognizable by those of ordinary skill in the art.

FIG. 1 illustrates exemplary process 100 for managing worker profiles and worker tasks. At block 102, a project may be generated for a worker or a team of workers to complete. In one embodiment, workers in an organization may have mobile devices (e.g., cell phones, laptop computers, tablet computers, etc.) that include software (e.g., an application or “app”) for receiving work assignments, reporting progress on those assignments, receiving company communications, sending messages, managing user profiles, and the like. The mobile devices may communicate with a central server that transmits tasks, tracks progress, manages worker profiles, and the like. An Internet interface may also be provided that allows managers, supervisors, or the like to monitor projects and personnel status.

In one exemplary embodiment, an organization may be tasked with cleaning aircraft cabins, and personnel may include cabin cleaners. When a flight segment is completed, the airplane may be cleaned and prepared for new passengers and a subsequent flight segment. Cabin cleaners may be assigned to move from plane to plane around an airport and to complete certain cleaning tasks for each plane. In some embodiments, a team of workers may be formed for cleaning a particular plane or set of planes. Workers may be selected from a pool of workers to form a team. For example, FIG. 2A illustrates an exemplary team management interface (e.g., a graphical user interface or “GUI”) that a team leader may access on a mobile device to form a team for completing a new project. As illustrated in FIG. 2A, the exemplary team management interface may include a list 210 of available workers along with their skills 212, experience levels 214, qualifications, ratings, and the like. A team leader may select various workers in preparation for completing a new project or mission. For example, FIG. 2B illustrates exemplary team 216 of three workers, including cleaning team leader User A and cleaning agents User B and User C. The team leader's mobile device may communicate the worker selections to the central server, and the central server may receive the worker selections and notify workers that they have been added to a team by transmitting messages to mobile devices of those workers. For example, the central server may send notifications to the mobile devices of User B and User C that they have been selected for a team led by User A. In other embodiments, teams may be formed automatically based on skills or the like, or team formation may be randomized to give different workers a chance to work on different teams. In some instances, teams may include a single worker who may be assigned a certain project to complete alone.

With a cleaning team formed, a new project may be generated for the team to complete. In one embodiment, projects may be generated automatically based on a variety of factors. For example, a new cleaning project may be automatically generated for each arriving aircraft that will need to be cleaned. In another embodiment, team leaders may have particular project assignments, and team leaders may enter project details on their mobile devices to generate a new project for their selected teams to complete. For example, FIG. 3A illustrates an exemplary interface 318 for generating a new project (or mission) on a mobile device. Project information, such as airline, aircraft model, location (e.g., terminal, gate, etc.), mission type (domestic flight cleaning, international flight cleaning, overnight plane cleaning, etc.), and the like, may be collected.

FIG. 3B illustrates a newly generated project in an exemplary project management interface 320. In the illustrated example, the generated project is a domestic flight cleaning (e.g., domestic turn) of an A319 aircraft, operated by Airline, arriving at gate two. In some cases, the same project may occur multiple times a day as flights cycle in and out of a particular gate. For example, a team may be tasked with cleaning all aircraft arriving at a particular group of gates throughout the day. A team leader may identify each of those projects (each different aircraft, each different gate, etc.) in preparation for working with those aircraft during a shift. In other embodiments, new projects may be generated based on any combination of flight schedules, flight status, worker availability, worker skills, worker preferences, aircraft model groups, project locations, and the like.

With teams formed and team projects identified, actual project instances may be generated and accepted to complete. For example, as illustrated in FIG. 3B, aircraft arrival time 322 and expected cleaning completion time 324 may be transmitted to workers' mobile devices. Workers may then select upcoming projects to complete based on the current time, aircraft arrival time, completion time, worker availability, and the like. As illustrated in FIG. 4, the aircraft tail number (or other identifying information) may be input in aircraft interface 426 to identify a particular plane to clean, or the aircraft tail number may be transmitted to workers' mobile devices to verify by sight that the correct aircraft is available for cleaning at a gate.

In other embodiments, dispatching projects may be automated, and teams of workers may be assigned different projects based on real-time needs. For example, the status of arriving aircraft may be monitored, and cleaning teams may be dispatched automatically based on the arrival times and/or subsequent departure times of the aircraft along with worker availability. In another example, the location of cleaning teams may be monitored, and the teams may be dispatched based on proximity to the planes that need to be cleaned. In yet another example, cleaning projects may be distributed to provide different workers with a variety of project types to keep workers engaged while also providing opportunities for workers to gain new skills with new assignments (e.g., different aircraft models, different cabin configurations, etc.).

Referring again to process 100 of FIG. 1, at block 104, project tasks may be transmitted to a worker's mobile device or team members' mobile devices. Project tasks may be transmitted over a wireless network (e.g., cellular network, wireless Internet network (e.g., Wi-Fi), etc.). An exemplary project may be broken up into a variety of discrete tasks, such as cleaning a particular lavatory, cleaning a particular row of seats, cleaning a particular section of the floor, and the like, and the various tasks may be distributed across team members. Different aircraft with different cabin configurations may have different predefined tasks. The distribution of tasks to workers on a team may be based, at least in part, on the number of workers on a team and the profiles associated with those workers (including their qualifications, experience level, etc.). For example, cleaning tasks involving the flight deck of an aircraft may require a special certification as not all personnel may be permitted to enter that area. Likewise, one project task may include leading the team of workers and overseeing the project, which may require a certain experience level or certification as a qualification. Tasks may also be evenly distributed based on expected task completion times to ensure equal division of labor and at least partially coordinated completion times. Some tasks may also be distributed as a reward to workers who have reached a certain performance level (e.g., assigning preferred tasks to workers who have met certain requirements or reached certain goals).

In one embodiment, tasks may be automatically divided among a team of workers. In another embodiment, a manager, supervisor, team leader, or the like may determine the distribution of tasks and enter them through a web interface, mobile device application, or the like. In some instances, team leaders managing a project through a mobile device may be able to modify task assignments prior to the start of the project (or during the project as needs change). Likewise, team leaders managing a project through a mobile device may be able to modify the team's membership prior to the start of the project (or during the project as needs change).

With project tasks divided (e.g., among a team), the various project tasks may be transmitted to workers' mobile devices. Transmitting the project tasks to workers' mobile devices may aid workers preparing for a project. FIG. 5 illustrates an exemplary task assignment view. A task assignment view may include illustration 546 of the particular aircraft to be cleaned (e.g., a floor plan, map, diagram, floor layout, etc.) with the different areas and tasks highlighted, circled, or otherwise marked. In the illustrated example, User A is assigned the task of cleaning the flight deck, and the flight deck area is marked with highlighting 548. Locational marker 550 may be provided to indicate where to begin the cleaning and where to end. In the example illustrated in FIG. 5, the flight deck is both the start and stop location, so a single locational marker 550 may be provided. In other examples, a start location marker and stop location marker may be illustrated separately. In addition to the view illustrated in FIG. 5, instructions may be transmitted to mobile devices including text, images, icons, symbols, animations, and the like to aid workers in performing the assigned tasks. For example, icon 579 may correspond to cleaning the flight deck, which may provide a ready reference to workers quickly glancing at their mobile devices and may instruct users regardless of their language skills or literacy. An indication of needed tools, provisions, or the like may also be transmitted to mobile devices to aid workers to come prepared with the appropriate tools for the assigned tasks. A help button 580 may be provided to access task completion instructions and tool suggestions.

FIGS. 6A and 6B illustrate additional exemplary task assignments views of task assignments that may be transmitted to workers' mobile devices. In the illustrated examples, User B is assigned the task of cleaning the lavatories of the aircraft, which may be marked with highlighting 648. Icon 679 may correspond to the task of cleaning the lavatories and may provide useful instructions to workers regardless of their literacy or language skills. In other embodiments, images, figures, animations, or the like may be provided as an indicator of the assigned task. A start locational marker 650 may indicate where the worker is expected to begin cleaning, and a stop locational marker 652 may indicate where the worker is expected to finish cleaning. Such locational markers may aid in improving project efficiency by coordinating and ordering tasks to optimize team performance. For example, prior to the task of cleaning the lavatories, a worker may be assigned to clean the front galley of an aircraft. As the worker is positioned at the front of the aircraft upon completion of the galley cleaning, it may be most efficient to have the worker next begin cleaning the front lavatory as opposed to starting with the rear lavatories. Similarly, including locational markers to direct workers may provide an opportunity to distribute workers throughout an aircraft to minimize interference and improve cleaning effectiveness (e.g., avoiding vacuuming the floor where someone else is cleaning debris off of seats, scheduling floor cleaning after upper surfaces have been cleaned to capture any fallen debris, etc.).

In addition to transmitting task assignments to mobile devices, instructions for completing the assigned tasks may be transmitted to mobile devices to prepare workers for upcoming tasks, remind workers of task expectations, and the like. For example, FIG. 7A illustrates task description 728 along with a list of steps 730 that may be included in completing the task (such information may be accessed, for example, using help button 580 of FIG. 5). In the illustrated example, the task of cleaning aircraft lavatories may include removing trash from, cleaning, and provisioning the aircraft lavatories. Various steps may be provided including removing trash, scrubbing countertops, scrubbing toilets, and the like. The various steps may be broken down further into sub-elements 732 as illustrated in FIG. 7B. For example, sub-elements may be transmitted to describe that removing trash may include removing trash from the trash can as well as removing any trash from the countertops and floor. Likewise, scrubbing countertops may include removing dirt or stains from the countertops and sink basin.

In some embodiments, a list of tools or provisions that may be used for a task may also be transmitted to workers' mobile devices. For example, FIG. 7C illustrates a list of provisions or tools 734 that may be used for the task of cleaning aircraft lavatories. A worker receiving a task assignment on a mobile device may gather the listed tools in preparation for completing the assigned task. In the illustrated example, the assigned worker may gather a red microfiber towel, glass cleaner, lavatory sponge, toilet brush, air freshener, safety mask, lavatory provisions, and the like. In this manner, before beginning a project, workers may be notified not only of their assigned tasks and the steps that may be involved in completing the assigned tasks, but also of the various provisions and tools that may be used to complete their assigned tasks, allowing workers to come fully prepared for the project upon arrival at the designated location.

Information indicating satisfactory task completion may also be transmitted to workers' mobile devices. For example, FIGS. 8A and 8B illustrate exemplary task completion views indicating unsatisfactory and satisfactory task completion, respectively. In some embodiments, textual description 856 may be provided to instruct workers on the expectation of satisfactory task completion. In the illustrated example, a sub-element of a lavatory cleaning task may include restocking lavatory provisions (e.g., soap, toilet paper, hand towels, etc.). Satisfactory completion of that sub-element may be textually described as all required lavatory provisions having been restocked as illustrated in FIGS. 8A and 8B. In addition to textual description 856, images, photographs, graphics, animations, or the like may be transmitted to mobile devices to provide a clear indication to workers of task expectations. For example, FIG. 8A illustrates a task “fail” image 858 where toilet paper was not restocked in an aircraft lavatory. In contrast, FIG. 8B illustrates a task “pass” image 860 where toilet paper was appropriately restocked in an aircraft lavatory. In this manner, workers may be provided—through mobile devices—with clear guidance on the expectations of certain project tasks. By including task instructions and clear guidance on satisfactory and unsatisfactory task completion or outcome, workers may also feel a sense of control over their careers by understanding clearly the performance expected of them and how they might achieve positive ratings, reviews, or the like.

With task assignments and instructions transmitted to workers' mobile devices, workers may assemble and prepare to complete the project. In one embodiment, worker locations may be tracked and monitored using global positioning hardware built into workers' mobile devices (e.g., GPS). Notifications or data relating to worker movements may be received and used, for example, to track project progress, track worker availability, identify the status of various projects of various teams, or the like. Project assignments and timing may also be managed by monitoring worker locations. For example, assigning new projects to workers may be done automatically based on workers leaving a project site in order to direct them where to go for their next assignment.

In some embodiments, workers arriving at a project site may use their mobile devices to transmit their arrival in preparation for beginning their tasks. FIG. 9, for example, illustrates an exemplary project site arrival interface workers may use to signal their arrival at a project location. As illustrated, a site arrival interface may indicate project information including airline, gate, project type, aircraft type, aircraft arrival time, expected cleaning completion time, etc. In one embodiment, workers' mobile devices may include near field communicator hardware (e.g., near field communication or “NFC”) that may be used to establish radio communication with devices or NFC tags that may provide identification information to the mobile devices. For example, NFC button 960 may be used to initiate NFC reading of a tag located at a gate, on a plane, on a door, or the like. The tag may provide (via radio-frequency identification or “RFID”) data relating to its location, such as identifying the serial number of an aircraft, the door of an airport, the gate, or the like. The mobile device may transmit that information, and that information may be received in order to monitor project status and confirm workers are handling assigned tasks.

In some embodiments, workers' mobile devices may include a camera or other hardware capable of reading or scanning a bar code. Bar code button 962 may be used to initiate bar code scanning or reading. Similar to NFC tags discussed above, a bar code may be provided at a gate, on a plane, on a door, or the like. Scanning the bar code may provide information to the mobile device, such as a series of numbers that may be matched (e.g., in a look-up table) with a particular aircraft or location. The mobile device may transmit that information, and that information may be received in order to monitor project status and confirm worker arrival at the project site. In some instances, some project sites may not include NFC tags or bar codes, and a manual entry method may be provided to indicate worker arrival. For example, manual entry button 964 may be used to initiate manual entry of a project location (e.g., selecting a location from a list, selecting an aircraft from a list, inputting a serial number manually, etc.). In this manner, worker location may be monitored to verify projects are being handled, monitor project status, and the like.

In one embodiment, a team leader may be presented with a site arrival interface (such as that illustrated in FIG. 9). The team leader may signal the team's arrival at a project site and prepare the workers to begin assigned tasks. In other embodiments, each individual may be presented with a site arrival interface to confirm arrival at project sites, thereby allowing for different arrival times and project start times for different workers, as well as offering finer monitoring of each individual to provide more accurate task completion status and more detailed worker performance tracking.

In some embodiments, the amount of time workers take to complete assigned tasks may be tracked as part of performance reviews, to provide a measurement tool for comparisons, to determine incentives, and the like. Workers' mobile devices may include timers that track the elapsed time for individual tasks, start and stop times may be monitored, a central timekeeper may be used, or any of a variety of other methods may be used to track the time it takes workers to complete assigned tasks. In one embodiment, a project start interface may be provided as illustrated in FIG. 10. A start button 1070 may cause a timer to begin counting the elapsed time. Alternatively or in addition, the current time and a later stop time may be recorded as timestamps and kept as a record of activity. In some embodiments, each individual worker may start their own timer corresponding to their own assigned tasks. In other embodiments, the team leader may start time ticking for the entire team, with the expectation that all workers begin work at around the same time. In still other embodiments, a remote supervisor or manager may start the time, or the time may be started automatically based on location, expected start time, or the like. In some embodiments, when time starts, notifications may be sent to workers' mobile devices to notify workers that the time for completing a task is being recorded, and that the timer has started ticking for their current assignment.

During task completion, a variety of information may be provided to workers, team leaders, supervisors, managers, and the like. FIG. 11A illustrates, for example, a task tracking interface that may indicate the current status of individual workers. As illustrated, workers may be listed (e.g., User A and User B). The current tasks of workers may also be listed in text, graphically illustrated (e.g., symbols, icons, animations, etc.), or the like. For example, in FIG. 11A, trash can symbols 1176 may indicate that both workers are currently involved in the task of clearing trash from aircraft seats. Timers 1178 may also be provided to indicate information such as the amount of time that has elapsed on a task, the expected amount of time remaining for a task, the overall time elapsed for a project, the time available for completing the project before the estimated completion time, or the like. In some embodiments, pause button 1172 may be provided to pause the clock counting for a particular project, and project end button 1174 may be provided to terminate a project or indicate project completion.

FIG. 11B illustrates another task tracking interface that may be provided to workers, team leaders, and the like. The interface illustrated in FIG. 11B may be similar to or the same as the interfaces illustrated in FIG. 5, FIG. 6A, and FIG. 6B discussed above, including, for example, start location markers and stop location markers (e.g., stop location marker 1152). The information used to generate the interface illustrated in FIG. 11B may be transmitted to workers' mobile devices to aid them in completing their tasks. As discussed above, stop and start location markers may provide direction to workers on how to approach a task. In FIG. 11B, for example, the worker tasked with cleaning the seats on the right side of the aircraft (e.g., User A) may have been instructed through the mobile device interface to begin at the front of the aircraft and work back, finishing at row twenty.

A timer 1184 may be provided to indicate the amount of time elapsed, the expected amount of time remaining for a task, the amount of time remaining on a project, or the like. A help button 1180 may be provided to access task completion instructions. For example, task completion instructions may be transmitted to workers' mobile devices and made available through an interface as illustrated in FIG. 11B with button 1180. Such instructions may be provided as illustrated in FIGS. 7A, 7B, 7C, 8A, and 8B, including, for example, detailed textual descriptions, graphics or images, satisfactory completion descriptions and images, provisions lists, and the like. By transmitting instructions to workers' mobile devices, workers may refer back to task descriptions and instructions as needed to ensure they are completing their tasks as desired.

Using their mobile devices, workers may signal when they have completed particular tasks. For example, button 1182 of FIG. 11B may be used to signal task completion, to move on to the next task, to complete a project, or the like. Notifications of task completion may be received and used to track worker performance, including the amount of time elapsed for completing particular tasks and/or projects. In some embodiments, workers may be discouraged from disingenuously signaling task completion by limiting when task completion may be reported. For example, expected completion times for particular tasks may be transmitted to workers' mobile devices, including, for example, expected minimum completion times, expected average completion times, expected maximum completion times, and the like. Expected completion times may or may not be provided or displayed for workers to view (e.g., expected completion times may be used to track performance without revealing the specific times to workers). If a worker attempts to signal a task is complete before the expected minimum completion time has elapsed, a notification may be provided, such as exemplary notification 1236 illustrated in FIG. 12, indicating that it appears the task was completed too quickly, and the worker will be able to signal task completion after more time has elapsed. In this manner, integrity in reporting may be encouraged by discouraging falsely reporting task completion before an expected minimum amount of time has elapsed.

In some embodiments, expected task completion times may be transmitted to workers' mobile devices and used to generate visual indicators, aural indicators, or the like to indicate a general performance level based, for example, on elapsed time. FIGS. 13A and 13B illustrate exemplary visual indicators 1386 and 1388 to signal to a worker how much time has passed and how that amount of time may correspond to expected performance. For example, in FIG. 13A, a seat cleaning task may be in progress, and completion at the time illustrated in FIG. 13A may be considered good performance. As such, visual indicator 1386 may be provided to signal to a worker that completing the task near the illustrated current time (e.g., 12 minutes 18 seconds remaining of the maximum allotted time) may be preferable and may result in favorable performance records. Visual indicator 1386 may include a colored background (e.g., green) for a portion or all of the task interface view. In contrast, FIG. 13B may correspond to a seat cleaning task where too much time has elapsed, indicating relatively poor performance. As such, visual indicator 1388 may be provided to signal to a worker that completing the task near the illustrated current time (e.g., 7 minutes 56 seconds remaining of the maximum allotted time) may correspond to poor performance, so completing the task as soon as possible may be preferable. Visual indicator 1388 may include a colored background of a different shade (e.g., red) than visual indicator 1386.

In some embodiments, visual indicators may gradually change colors, shades, or the like to convey a gradient of completion times corresponding to a range of performance expectations. For example, at a time corresponding to good performance, a green visual indicator may be provided. The visual indicator may then transition gradually to yellow as a time approaches corresponding to acceptable performance. The visual indicator may then transition gradually to red as a time approaches corresponding to poor performance. In some embodiments, aural indicators (e.g., chimes, tones, voice recordings, etc.) may be used instead of visual indicators or in addition to visual indicators Likewise, in some embodiments, visual indicators may flash, blink, or be animated in various ways to draw worker attention and signal a performance level corresponding to the amount of time that has elapsed in completing a particular task.

As workers complete tasks, they may signal task completion using their mobile devices and may be presented with a task completion interface. In one embodiment, as illustrated in FIG. 14, a task completion interface 1438 may include a confirmation question. Including such a confirmation may prevent accidental button presses with false-positive task completion times. Upon task completion and confirmation, workers' mobile devices may send notifications of task completions. In some embodiments, task notifications may be transmitted in real time. In other embodiments, task data (e.g., start time, stop time, elapsed time, etc.) may be transmitted as a batch upon project completion or at another time. Workers who have completed all assigned tasks may be given new assignments, may be prompted to help other workers, may be notified of a break period while the remainder of the team finishes, or the like. A team leader may also be responsible for transmitting a notification that the entire project is complete and directing workers to move on to the next project or task.

Referring again to process 100 of FIG. 1, at block 106, notifications of task completion may be received. Such notifications may be received in real-time as tasks are completed, in a batch upon completion of a project, at intervals to incrementally track progress, or at various other times in a variety of ways. Task completion notifications may include, for example, data that identifies the particular worker completing the task, the task that was completed, the project to which that task belongs, the start time of that task, the stop time of that task, the time elapsed to complete the task, and/or a variety of other information useful to track project progress and worker performance. In some embodiments, workers may also be able to transmit notes, comments, or other data as part of a task completion notification (e.g., noting a significant mess that may have taken longer than normal to clean, noting a tool malfunction, or the like), and those notes may be received and recorded along with other task completion notification data.

Referring again to process 100 of FIG. 1, at block 108, cumulative experience scores of team members or of an individual worker may be accessed from a database. At block 110, the cumulative experience scores may be updated based on task completion, and the updated cumulative experience scores may be stored in the database at block 112. In one embodiment, each worker may have an associated profile that includes a variety of information about work experience, performance, quality, feedback, certifications, and the like. As workers complete tasks and are rated or reviewed, their profiles may be updated to reflect additional experience and performance ratings. Upon receiving a task completion notification, for example, a cumulative experience score in the profile of the associated worker may be incremented to reflect that the worker has completed another task and gained additional experience. A cumulative experience score may reflect the cumulative amount of work experience of a worker over a particular time (e.g., lifetime, career, current position, current level, etc.). For example, experience points may be awarded for each completed task, and a running total of experience points may be tracked and provided to workers as a reward and motivation, as well as providing a referential tool for management to track the career progress of each worker using a uniform score to compare workers, which may be used in making advancement decisions. In some embodiments, each task may have a predetermined number of experience points associated with it. More difficult or time consuming tasks may be associated with more experience points, while simpler or shorter tasks may be associated with fewer experience points.

In some embodiments, the incremental amount added to a worker's cumulative experience score may be based on the timeliness of task completion. For example, a task notification may be received along with the time elapsed in completing the task. For average completion times, a predetermined number of points may be added to a worker's cumulative experience score. For below average completion times, fewer points may be added. Likewise, for above average completion times (faster, more efficient performance), additional points may be added to a worker's cumulative experience score beyond the predetermined average. The quality of work, audit ratings, and the like may also be used to determine the number of points to add to a worker's cumulative experience score, as will be discussed in further detail below. In other embodiments, separate cumulative experience scores may be maintained for experience, timeliness, quality, and the like.

Beneficially, by providing workers with frequently-updated (in some cases real-time) scores reflecting work experience, workers may be better motivated and more engaged in their work. In particular, a higher cumulative experience score, for example, may be awarded almost instantly upon completion of a task, thereby providing a sense of satisfaction to each task as a cumulative experience score changes. FIG. 15, for example, illustrates an exemplary project status and score review interface 1526 that may be available to workers who may still be completing related tasks on a project. A list of tasks 1528 may be provided noting each task the worker has been assigned for a given project (e.g., seat clean, hard surfaces, flight deck, etc.). A number of experience points 1532 awarded for completed tasks may be transmitted to workers' mobile devices and almost instantly provided for workers to review. In the illustrated example, User A was awarded two experience points 1532 for his performance in cleaning aircraft seats and one experience point 1532 for his performance in cleaning hard surfaces of the aircraft.

In addition to the number of experience points awarded for task completion, a percentage score 1530 may be provided for tasks reflecting, for example, how the worker's time in completing a task was rated. In the illustrated example, User A may have taken longer than average to complete the seat cleaning task, so he may have been given a score of 55% for that task. In some embodiments, the two experience points for that task may be based in part on the percentage score (e.g., five points may have been available for the most efficient completion, but two points may have been awarded based on a slower completion time). Thus, as task completion notifications are received, cumulative experience scores may be updated, performance ratings may be updated, and related data may be transmitted to workers' mobile devices to provide real-time awards for task completion that may better engage workers in their tasks.

FIG. 16 illustrates an exemplary worker profile with cumulative work experience scores that may be updated, for example, as tasks completion notifications are received. Such a profile may be updated over time and transmitted to workers' mobile devices to allow workers to monitor their personal progress (as well as providing data for making compensation and advancement decisions). As illustrated, a worker profile may include a variety of information including level 1640 that may indicate a particular career stage within an organization (e.g., level two may reflect a certain job description, amount of experience, skill level, pay grade, etc.). A cumulative work experience score 1642 may also be included that may reflect generally the amount of work experience the worker has had. As illustrated, User A may have accumulated 280 experience points over his career from completing assigned tasks. An overall percentage rating 1644 may also be included that may reflect ratings, reviews, timeliness, quality, audits, feedback, or the like. For example, a rating of 89.4% may be based on an average time to complete tasks that exceeds the expected amount of time. Likewise, the rating may be based on quality reviews or consistency in performance. In other examples, the rating may be a combination of a variety of performance indicators as desired.

In addition to level, experience points, and rating, a worker profile may include a number of experience points 1646 that may be needed to achieve the next career stage. In the illustrated example, User A may need 2719 additional experience points before reaching the 2999 experience points required to reach level three. Various other goals, stages, levels, or the like may also be included to allow workers to monitor their frequently-updated progress, much like levels of a game may be provided to illustrate progress to game participants. A chart 1648 or similar graph, image, or the like may also be provided to illustrate graphically how a worker is progressing. A worker profile may also include other cumulative experience scores or data that provide progress feedback to workers. For example, the number of projects completed may be monitored and reported (e.g., 203 career missions), the percentage of experience points obtained toward a next level may be reported (e.g., 7%), the number of experience points obtained since achieving the last level may be reported (e.g., 51 experience points), and the like. Worker profiles may thus be updated frequently and related data transmitted to workers' mobile devices to allow progress monitoring and the sense of engagement and satisfaction that may be associated with such feedback.

FIGS. 17A, 17B, and 17C illustrate exemplary worker profiles with certifications, awards, and statistics, respectively, that may likewise be updated and transmitted to workers' mobile devices as workers progress. FIG. 17A illustrates a view of a worker profile that may reflect various certifications 1750 that the associated worker may have obtained. In some instances, certifications may be desired (or even required) for workers to complete certain tasks. For example, handling certain chemicals or equipment may require safety certifications or the like. Certifications may be obtained, for example, by completing courses (e.g., live training, video training, etc.). Certifications obtained may then be reflected in worker profiles indicating their ability to perform certain related tasks. In the illustrated example, User A may have obtained a variety of certifications including cleaner, detailer, sterilizer, finisher, and lead. In some embodiments, worker certifications may be used to determine which project tasks to assign to workers.

FIG. 17B illustrates a view of a worker profile that may reflect various awards 1752 that the associated worker may have obtained. In some embodiments, awards may be automatically given when workers reach certain progress levels or reach target goals in quality, efficiency, timeliness, or the like. For example, a timeliness award may be automatically awarded to a worker and reflected in the associated profile when the worker completes an assigned task in a predetermined amount of time. Similarly, a progress award may be automatically awarded to a worker and reflected in the associated profile when a worker reaches a certain level of experience, certain number of positive reviews, certain rating, or the like. Awards may also be given by supervisors, managers, or the like and reflected in worker profiles. In some embodiments, awards may be used to determine compensation, bonuses, career advancement, task assignments, and the like.

FIG. 17C illustrates a view of a worker profile that may reflect various statistics 1754 relating to the associated worker's performance. In one embodiment, performance statistics may be tracked for different task types. For example, separate performance statistics may be tracked for seat cleaning, provisioning, hard surface cleaning, leading, flight deck cleaning, and the like. A percentage score may be provided for various tasks that may reflect timeliness, quality, experience, or the like. In some embodiments, task performance statistics may be based on percentage ratings achieved for completed tasks, such as percentage rating 1530 of FIG. 15. Some or all of such ratings for a particular task may be averaged, and the average may be provided as a statistic or score 1754, as illustrated in FIG. 17C. For example, the average performance rating of all flight deck cleaning tasks User A completed may be reported as a statistic 1754 (e.g., an average performance score of 74%). The score may also be graphically illustrated as a bar graph, and the scores may be listed in rating order.

In some embodiments, completed projects may be subject to an audit to, for example, review worker performance, monitor quality, and the like. For example, once a project is completed, an audit request may be automatically generated and transmitted to an auditor. A worker responsible for auditing a project may be similar to cleaners and other workers and may receive auditing tasks via a mobile device, and may track auditing progress using a mobile device. In addition, an auditor may enter feedback and submit an audit report via a mobile device. FIGS. 18A, 18B, and 18C illustrate exemplary project audit interfaces. FIG. 18A illustrates a project audit interface 1840 that may provide audit assignment details, much like task assignment details illustrated in FIG. 4 and discussed above. In some embodiments, audit tasks may be automatically generated when projects are completed. In some instances, all completed projects may be subject to audits, or a subset of completed projects may be subject to audits. Audited projects and tasks may be evenly distributed across team leaders, team members, workers, project types, or the like to ensure all workers are subject to roughly the same amount of review. As such, the projects to audit may be determined based on a variety of factors including which workers have been audited and when, which tasks have been audited and when, which workers have been under-performing and may need extra review, which workers are new and may need extra review, or the like.

After the projects to audit have been determined, audit tasks may be transmitted to mobile devices of auditors. Audit tasks may include a variety of information, such as that illustrated in FIG. 18A. For example, data relating to the aircraft, airline, project type, flight status, dates, times, and the like may be included in an audit task. In some embodiments, auditors may be blind to the workers who participated in a project to ensure integrity in the review process. After an auditor receives an audit task assignment, the auditor may accept the assignment and begin the audit. Like cleaning tasks discussed above, auditor tasks may also be tracked for timeliness and the like.

In some embodiments, audits may be comprehensive of all areas and all tasks of a project. In other embodiments, however, a select subset of areas and tasks may be audited, and the selected subset may be transmitted to the auditor's mobile device. FIG. 18B illustrates an exemplary project audit interface 1842 with selected audit areas 1860 highlighted for an auditor to review. Determining the areas and tasks to review may be based in part on the distribution of tasks to workers to ensure that tasks completed by each worker are reviewed equally. As mentioned above, the workers who completed the various tasks under audit may be blind to the auditor during the review process. In the illustrated example, selected audit areas 1860 may include the flight deck and the forward lavatory. FIG. 18C illustrates another exemplary project audit interface 1842 with selected audit areas 1860 highlighted for an auditor to review. In the example illustrated in FIG. 18C, various aircraft seats are selected and highlighted for the auditor to review. The particular seats may be determined semi-randomly while taking into account fairness in providing an even distribution of audits across workers (e.g., if four workers cleaned four groups of seats, an equal number of seats may be randomly selected from each of the four groups for audit).

In auditing the project, auditors may select an audit area 1860 to audit and may be presented with project audit feedback interfaces, such as those illustrated in FIGS. 19A and 19B. FIG. 19A illustrates a list of audit review points that may be used in auditing a flight deck cleaning task. As illustrated, descriptions 1962 may be transmitted to the auditor's mobile device and provided to indicate the basis of review (e.g., the flight deck floor is or is not free of trash and debris, the flight deck seats are or are not free of trash, etc.). Feedback ratings 1964 (e.g., buttons, numbers, etc.) may be provided for the auditor to indicate whether performance passed or not, or, in some cases, a level of performance, a score, a rating, or the like. In addition to descriptions 1962, task instructions may also be transmitted to the auditor's mobile device to provide a reference for task expectations (e.g., task instructions such as those illustrated in FIGS. 7A, 7B, 7C, 8A, and 8B).

In some embodiments, when an auditor indicates that performance did not meet expectations, the auditor may be presented with a project audit feedback interface such as the interface illustrated in FIG. 19B. Auditors may be prompted with interface 1966 to capture a photo using a camera (e.g., a camera integrated into a mobile device) to document the reason the task completion did not meet expectations. Auditors may also be prompted with interface 1968 to textually describe why the reviewed item failed. In other embodiments, passing reviews may also include text and picture documentation to record good performance. The auditor's ratings may be stored in the mobile device and/or transmitted for record-keeping. Images collected as documentation as well as textual descriptions may also be transmitted for record-keeping. Other feedback may also be included such as overall project reviews, scores, percentages, summary pictures, and the like. After an auditor reviews all identified areas and tasks, the auditor may indicate audit completion and may then be permitted to review the audit report. In some instances, an auditor may be permitted to view the individual workers responsible for different tasks and areas after the audit data has been finalized and submitted.

Auditor feedback may be received (including ratings, images, text, audio, etc.) and used to generate project audit reports as illustrated in FIGS. 20A and 20B. In some embodiments, audit feedback data may be received from the mobile device of the auditor and used to generate an audit report that may be transmitted to the mobile devices of the workers who completed the project. In this manner, workers who recently completed the audited project may get feedback near the time of completing the project and quickly learn from any identified mistakes in addition to getting a sense of satisfaction for positively-reviewed tasks. As illustrated in FIG. 20A, an audit report may include summary scores such as overall project rating 2070 that may, for example, reflect an average rating or pass rate of all reviewed tasks. The report may also include a list 2072 of all reviewed tasks or areas along with the associated rating or pass rate for those tasks or areas. For example, as illustrated in FIG. 20A, the flight deck cleaning task may have failed and been given a 0% rating, while the floor cleaning task (or tasks) may have passed with a 100% rating.

FIG. 20B illustrates a project audit report with audit documentation. In some embodiments, audit documentation may be provided only for failing tasks (such as flight deck cleaning illustrated in FIG. 20A). The failed outcome report of FIG. 20B may include a variety of information to document reasons for failure while also providing instruction to workers to improve and avoid subsequent failures. For example, photograph documentation 2066 may be transmitted to workers' mobile devices to indicate visually why a task was given a failing rating. Such a photograph may have been collected during the audit such as is described above with reference to photo capture interface 1966. Textual description 2068 may also be transmitted to workers' mobile devices to describe the conditions found or reasons for the failing rating. In FIG. 20B, for example, photograph 2066 may illustrate trash in a flight deck seat, and description 2068 may describe that trash was found in the seat, thereby leading to a failing rating for the task. In some embodiments, summary reports, such as that illustrated in FIG. 20A, may be provided to all workers while detailed reports linked to individual workers, such as that illustrated in FIG. 20B, may be transmitted only to those individual workers who completed the tasks that were rated as failing.

In addition to generating audit reports, auditor feedback may be received (including ratings, images, text, audio, etc.) and used to update worker profiles (such as the profiles illustrated in FIGS. 16, 17A, 17B, and 17C). Positive feedback may be used to add points to cumulative experience scores or update overall ratings. Likewise, negative feedback may be used to decrement cumulative experience scores or otherwise update overall ratings. In some embodiments, as discussed above with reference to FIG. 17C, ratings for tasks may be recorded, averaged, and reported as separate cumulative statistics, and audit feedback may be used to update such statistics. For example, a passing rating or failure rating on a flight deck cleaning task may be used to update the flight deck cleaning statistic in the profile associated with the corresponding worker. Audit feedback may also be used to generate awards (such as those illustrated in FIG. 17B) for good performance. In still other embodiments, an overall quality or consistency score may be included in worker profiles, and audit feedback may be received and used to update a worker's overall quality or consistency score.

In some embodiments, specialty tasks may be available that offer bonus experience points, awards, or other recognition to workers. For example, an interface may be provided on workers' mobile devices to document finding a lost item, a security breach, a maintenance problem, or the like. Workers may report documentation of their findings (e.g., photographs, text descriptions, locations, etc.) via their mobile devices, and that information may be transmitted. The documentation may then be received and used to reward workers. For example, finding a lost wallet and documenting the finding may correspond to an award of fifteen extra experience points added to the worker's cumulative experience score, which may also motivate honesty in reporting and returning such lost items. Similarly, identifying and reporting a maintenance problem, such as a burned out light bulb, may correspond to an award of one extra experience point added to the worker's cumulative experience score. Workers may thus be rewarded for engaging in such specialty tasks, which may further engage them in their work and provide satisfaction in performing their jobs well.

In addition to the various features discussed above, various embodiments may also include tools for engaging workers socially, distributing information, publicly praising performance, and the like. In some embodiments, a social network may be maintained and made accessible via workers' mobile devices as well as typical computers to facilitate worker association and collaboration. Such a social network may be accessible to a specific team, to a whole company, to the public at large, or the like. Workers may add friends and colleagues to their network, and status updates, messages, performance reviews, awards, and the like (e.g., a newsfeed) may be transmitted to the workers' mobile devices for those individuals added to their network. Such a newsfeed may also include public praise of individuals, teams, groups, or the like, whether or not they are part of a particular network. For example, when a team achieves a particular quality goal, speed goal, or the like, an announcement may be generated and distributed through the social network newsfeed to publicly praise that team Likewise, when an individual is given a particular award or is otherwise recognized for performance, an update may be transmitted as part of the social network newsfeed. Facilitating such a social network may further engage workers in their work and lead to a sense of teamwork and collectiveness.

Such a social network may also facilitate healthy competition among individuals, teams, groups, organizations, or the like. For example, cabin cleaners at one airport may compete against cabin cleaners at a different airport. The status of the two cabin cleaner teams may be monitored and transmitted to the workers' mobile devices to encourage competition and better performance. For example, timeliness ratings, quality ratings, or the like may be tracked for each team and distributed periodically as a newsfeed update to motivate each team in their work. Similarly, a leaderboard or ranked list may be transmitted to workers' mobile devices to publicly praise top performers. A leaderboard may, for example, rank individual workers or teams on experience, quality, timeliness, or the like over a specified period of time (an hour, a day, a week, a month, a year, etc.).

In addition to providing social network access and public praise, important company bulletins or messages may be transmitted to workers' mobile devices. In some embodiments, the viewership of such bulletins may be monitored by transmitting a notification after a bulletin has been viewed, after receipt has been acknowledged, after workers mark a message as read, or the like. Typical electronic mail may also be transmitted to workers' mobile devices and may be used for workers to communicate with each other Likewise, a voice communication interface may be provided on workers' mobile devices to facilitate communication among workers (e.g., via cellular networks, wireless Internet networks (e.g., Wi-Fi), or the like).

FIG. 21 illustrates exemplary system 2120 for managing worker profiles and worker tasks. System 2120 may include a web server 2122 that may facilitate communication throughout system 2120. Web server 2122 may communicate with mobile devices 2142, which may correspond to workers' mobile devices discussed herein. For example, mobile devices 2142 may be used by cleaning workers, team leaders, auditors, supervisors, or the like to manage tasks, view profiles, view social network newsfeeds, and the like. Web server 2122 may, for example, transmit tasks to mobile devices 2142 and receive task completion notifications from mobile devices 2142. Web server 2122 may also communicate with typical computers 2144 and may provide a web interface for accessing project status, project feedback, worker profiles, and the like. Computers 2144 may be used by managers, supervisors, team leaders, or workers to access project information, access training information, access project management interfaces, assign projects, assign tasks, submit feedback, or the like.

Web server 2122 may also communicate with application programming interface (API) router 2124. API router 2124 may provide an interface for various software components to communicate with each other, and may route communications among the various components. API router 2124 may facilitate system communication with public API 2138. Public API 2138 may provide an interface for public access to some system data. For example, public API 2138 may provide an interface for public interaction with a social network of system 2120. API router 2124 may also facilitate system communication with modular productivity software applications 2126 through a load balancer 2140. Load balancers 2140 may distribute workload across multiple computers, networks, processors, or other resources to achieve optimal resource utilization, maximize throughput, minimize response time, avoid overload, and the like. Modular productivity applications 2126 may include software instructions and data related to managing worker projects and tasks (e.g., aircraft cabin cleaning projects, task instructions, etc.). Modular productivity applications 2126 may communicate with databases 2136, which may store project data, task data, task instructions, expected task completion times, and the like, which may be used by modular productivity applications 2126 in managing projects and tasks. Modular productivity applications 2126 may include, for example, an aircraft cleaning application (as discussed herein), a hotel housekeeping application, a chauffeuring application, and the like.

API router 2124 may also communicate with company data service 2134 through a load balancer 2140. Company data service 2134 may manage company data, user data, worker profiles, and the like, which may be stored in one or more databases 2136. For example, company data service 2134 may manage data such as employee names, hire dates, contact information, and the like. API router 2124 may also communicate with game service 2132 through a load balancer 2140. Game service 2132 may manage project ratings, task scoring, experience points, timeliness tracking, quality tracking, awards, levels, and the like. In some embodiments, related data may be stored in one or more databases.

API router 2124 may also communicate with data service 2130 through a load balancer 2140. Data service 2130 may manage statistics, analytics, warehousing, and the like, and may cause data to be stored in one or more databases 2136. API router 2124 may also communicate with social service 2128 through a load balancer 2140. Social service 2128 may facilitate electronic messaging, newsfeed updates, voice communication, and the like among workers or other individuals in communication with the network. Related data may be stored in one or more databases 2136.

It should be appreciated that various elements of system 2120 may be omitted, combined, duplicated, or the like based on the needs of an organization, resource availability, design choice, and the like. For example, while multiple databases 2136 are illustrated in FIG. 21, a single database may serve all database functions for system 2120, or additional databases may be added Likewise, while load balancers 2140 are illustrated in various positions in system 2120, some or all load balancers 2140 may be omitted or combined. Similarly, while software services 2128, 2130, 2132, and 2134 have been illustrated as separate entities, they may be combined in one or more software modules. Various other system modifications will be apparent to those of ordinary skill in the art, and system 2120 should be recognized as a non-limiting example of system architecture.

FIG. 22 illustrates an exemplary computing system 2200 configured to perform any one of the above-described processes. In this context, computing system 2200 may include, for example, a processor (which may have multiple cores), memory, storage, and input/output devices (e.g., monitor, keyboard, disk drive, Internet connection, etc.). However, computing system 2200 may include circuitry or other specialized hardware for carrying out some or all aspects of the processes. In some operational settings, computing system 2200 may be configured as a system that includes one or more units, each of which is configured to carry out some aspects of the processes either in software, hardware, or some combination thereof.

FIG. 22 depicts an exemplary computing system 2200 with a number of components that may be used to perform the above-described processes. The main system 2202 includes a motherboard 2204 having an input/output (“I/O”) section 2206, one or more central processing units (“CPU”) 2208 (which may have multiple cores), and a memory section 2210, which may have a flash memory card 2212 related to it. The I/O section 2206 is connected to a display 2224, a keyboard 2214 (or other input mechanism), a disk storage unit 2216, and a media drive unit 2218. The media drive unit 2218 can read/write a non-transitory computer-readable storage medium 2220, which can contain programs 2222 or data.

At least some values based on the results of the above-described processes can be saved for subsequent use. Additionally, a non-transitory computer-readable storage medium can be used to store (e.g., tangibly embody) one or more computer programs for performing any one of the above-described processes by means of a computer. The computer program may be written, for example, in a general purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this disclosure.

What is claimed is:

1. A computer-implemented method for managing worker profiles and worker tasks, the method comprising:
generating, via a processor, a project, wherein the project comprises a set of tasks;
transmitting, over a wireless network, a subset of the set of tasks to a mobile device of a first worker;
receiving a notification that one or more tasks of the subset of the set of tasks are complete;
accessing a cumulative experience score associated with a worker profile of the first worker from a database;
updating the cumulative experience score based on the notification that the one or more tasks of the subset of the set of tasks are complete; and
storing the updated cumulative experience score in the database.

2. The computer-implemented method of claim 1, further comprising:
transmitting another subset of the set of tasks to a mobile device of a second worker.

3. The computer-implemented method of claim 1, further comprising:
transmitting instructions to the mobile device of the first worker for completing a task of the subset of the set of tasks.

4. The computer-implemented method of claim 3, wherein the instructions comprise an image illustrating an acceptable completion of the task and an image illustrating an unacceptable completion of the task.

5. The computer-implemented method of claim 3, wherein the instructions comprise a list of provisions for completing the task of the subset of tasks.

6. The computer-implemented method of claim 3, wherein the instructions comprise a list of steps for completing the task of the subset of tasks.

7. The computer-implemented method of claim 3, wherein the instructions comprise one or more of an icon, graphic, image, or animation that illustrates how to complete the task of the subset of tasks.

8. The computer-implemented method of claim 3, wherein the instructions comprise a diagram, and wherein the diagram indicates a location of the task of the subset of tasks.

9. The computer-implemented method of claim 1, further comprising:
transmitting an expected time of task completion to the mobile device of the first worker for a task of the subset of the set of tasks.

10. The computer-implemented method of claim 1, wherein updating the cumulative experience score associated with the worker profile comprises:
incrementing the cumulative experience score associated with the worker profile of the first worker.

11. The computer-implemented method of claim 1, further comprising:
receiving data corresponding to an elapsed time for completing the one or more tasks of the subset of the set of tasks.

12. The computer-implemented method of claim 11, further comprising:
updating a cumulative performance rating associated with the worker profile of the first worker based on the data corresponding to the elapsed time for completing the one or more tasks of the subset of the set of tasks.

13. The computer-implemented method of claim 1, further comprising:
transmitting a ranked list of a plurality of workers to the mobile device of the first worker, wherein the ranked list of the plurality of workers orders workers based on data associated with worker profiles of the plurality of workers.

14. The computer-implemented method of claim 1, further comprising:
transmitting a request for an audit of the project to a mobile device of an auditor;
transmitting a request for photographic documentation of audit feedback to the mobile device of the auditor; and
receiving photographic documentation of audit feedback.

15. The computer-implemented method of claim 14, further comprising:
transmitting the received photographic documentation of the audit feedback to the mobile device of the first worker, wherein the audit feedback is associated with a completed task of the one or more tasks of the subset of the set of tasks.

16. The computer-implemented method of claim 14, further comprising:
updating a cumulative performance rating associated with the worker profile of the first worker based on audit feedback.

17. A non-transitory computer-readable storage medium comprising computer-executable instructions for managing worker profiles and worker tasks, the computer-executable instructions comprising instructions for:
generating, via a processor, a project, wherein the project comprises a set of tasks;
transmitting, over a wireless network, a subset of the set of tasks to a mobile device of a worker;
receiving a notification that one or more tasks of the subset of the set of tasks are complete;
accessing a cumulative experience score associated with a worker profile of the worker from a database;
updating the cumulative experience score based on the notification that the one or more tasks of the subset of the set of tasks are complete; and
storing the updated cumulative experience score in the database.

18. The computer-readable storage medium of claim 17, the computer-executable instructions further comprising instructions for:
transmitting instructions to the mobile device of the worker for completing a task of the subset of the set of tasks.

19. The computer-readable storage medium of claim 17, the computer-executable instructions further comprising instructions for:
transmitting an expected time of task completion to the mobile device of the worker for a task of the subset of the set of tasks.

20. The computer-readable storage medium of claim 17, the computer-executable instructions further comprising instructions for:
receiving data corresponding to an elapsed time for completing the one or more tasks of the subset of the set of tasks.

21. The computer-readable storage medium of claim 20, the computer-executable instructions further comprising instructions for:
updating a cumulative performance rating associated with the worker profile of the worker based on the data corresponding to the elapsed time for completing the one or more tasks of the subset of the set of tasks.

22. A system for managing worker profiles and worker tasks, the system comprising:
a database configured to store data; and
a computer processor configured to:
generate a project, wherein the project comprises a set of tasks;
transmit, over a wireless network, a subset of the set of tasks to a mobile device of a worker;
receive a notification that one or more tasks of the subset of the set of tasks are complete;
access a cumulative experience score associated with a worker profile of the worker from the database;
update the cumulative experience score based on the notification that the one or more tasks of the subset of the set of tasks are complete; and
store the updated cumulative experience score in the database.

23. The system of claim 22, the computer processor further configured to:
transmit instructions to the mobile device of the worker for completing a task of the subset of the set of tasks.

24. The system of claim 22, the computer processor further configured to:
transmit an expected time of task completion to the mobile device of the worker for a task of the subset of the set of tasks.

25. The system of claim 22, the computer processor further configured to:
receive data corresponding to an elapsed time for completing the one or more tasks of the subset of the set of tasks.

26. The system of claim 25, the computer processor further configured to:
update a cumulative performance rating associated with the worker profile of the worker based on the data corresponding to the elapsed time for completing the one or more tasks of the subset of the set of tasks.
